(19) United States
(12) Patent Application Publication
(10) Pub. No.: US 2025/0188634 A1
(43) Pub. Date: Jun. 12, 2025

(54) SYSTEM AND PROCESS FOR EXTRACTING LITHIUM FROM A SALTWATER

(71) Applicant: SALTWORKS TECHNOLOGIES INC., Richmond (CA)

(72) Inventors: Xiangchun YIN, Richmond (CA); Benjamin SPARROW, Richmond (CA)

(21) Appl. No.: 18/845,383

(22) PCT Filed: Mar. 10, 2023
(86) PCT No.: PCT/CA2023/050324

§ 371 Date: Sep. 9, 2024

Related U.S. Application Data
(60) Provisional application No. 63/318,458, filed on Mar. 10, 2022.

(51) Int. Cl. C25C 1/02; C25C 7/02; C25C 7/04

(52) U.S. Cl. CPC C25C 1/02; C25C 7/02; C25C 7/04

(57) ABSTRACT

Methods, systems, and techniques for extracting lithium from a saltwater using an electrochemical apparatus that performs the lithium extraction. The electrochemical apparatus includes a four-chamber electrochemical cell with adjacent two saltwater chambers or two adjacent lithium recovery solution chambers. Each chamber is bounded by an anion exchange membrane and either a lithium-deintercalated electrode or a lithium-intercalated electrode. The lithium deintercalated electrode and the lithium intercalated electrode may include a saltwater-impermeable and electrically conductive substrate, and respectively a porous lithium-deintercalated media and a porous lithium-intercalated media in contact with one or more surfaces of the saltwater-impermeable and conductive substrate. The lithium-deintercalated electrode absorbs lithium from the saltwater and the lithium-intercalated electrode releases lithium into the lithium recovery solution when an electrical potential is applied to the lithium-deintercalated electrode and the lithium-intercalated electrode.

### CROSS-REFERENCE TO RELATED APPLICATION

The present application claims priority to U.S. provisional patent application No. 63/318,458, entitled “System and Process for Extracting Lithium from a Saltwater”, and filed on Mar. 10, 2022, the entirety of which is hereby incorporated by reference.

### TECHNICAL FIELD

The present disclosure relates to systems, processes, and techniques for electrochemical lithium extraction. More particularly, the present disclosure describes systems, processes, and techniques for selectively extracting lithium compounds (e.g., lithium chloride) from a saltwater through electrochemical lithium recovery systems and processes.

### BACKGROUND

Lithium is a key element of lithium-ion batteries, which are used for electric cars and power storage equipment. Although the Earth is abundant in lithium, there are relatively few lithium resources where lithium is found in concentrations sufficient for cost-effective production of lithium compounds. Lithium compounds are produced primarily from crystalline hard rocks (e.g., spodumene) and saltwaters (e.g., salar brines). Typically, lithium is extracted from a saltwater using evaporative concentration in evaporation ponds. The evaporation process is time consuming, land intensive, and wastes fresh water. Direct lithium extraction, which specifically extracts lithium compounds out of a saltwater and leaves other salts in the saltwater, has been explored to eliminate evaporation ponds for producing lithium compounds.

### SUMMARY

According to a first aspect, there is provided a system for extracting lithium from a saltwater, the system comprising an electrochemical lithium recovery apparatus comprising a first electrochemical cell, the first electrochemical cell comprising: a first chamber and an adjacent second chamber, wherein the first and second chambers are bounded by and share either an intermediate lithium-intercalated electrode or an intermediate lithium-deintercalated electrode; a third chamber adjacent the first chamber, wherein the first and third chambers are bounded by and share an anion exchange membrane; a fourth chamber adjacent the second chamber, wherein the second and fourth chambers are bounded by and share an anion exchange membrane, and wherein the third and fourth chambers are respectively also bounded by: cell boundary lithium-deintercalated electrodes when the first and second chambers are bounded by and share the intermediate lithium-intercalated electrode; and cell boundary lithium-intercalated electrodes when the first and second chambers are bounded by and share the intermediate lithium-deintercalated electrode.

The first and second chambers may be saltwater chambers for receiving the saltwater, the first and second chambers may be bounded by and share the intermediate lithium-deintercalated electrode, the third and fourth chambers may be recovery solution chambers for receiving a lithium recovery solution, and the third and fourth chambers may be respectively also bounded by the cell boundary lithium-intercalated electrodes.

The first and second chambers may be recovery solution chambers for receiving a lithium recovery solution, the first and second chambers may be bounded by and share the intermediate lithium-intercalated electrode, the third and fourth chambers may be saltwater chambers for receiving the saltwater, and the third and fourth chambers may be respectively also bounded by the cell boundary lithium-deintercalated electrodes.

Each of the intermediate electrodes may be shared by the first and second chambers and the cell boundary electrodes respectively bounding the first and second chambers may comprise a saltwater-impermeable and electrically conductive substrate.

The saltwater-impermeable and electrically conductive substrate may comprise a sheet substrate made from a material comprising at least one of titanium, graphite, a conductive polymer, and a polymer film coated with conductive materials.

The electrochemical lithium recovery apparatus may further comprise a second electrochemical cell sharing at least one of the cell boundary electrodes with the first electrochemical cell, and the second electrochemical cell may comprise an identical configuration of the four chambers as the first electrochemical cell.

The first and second chambers may be bounded by and share the intermediate lithium-intercalated electrode, the intermediate lithium-intercalated electrode may comprise a porous lithium-intercalated media affixed to the saltwater-impermeable and electrically conductive substrate of the intermediate lithium-intercalated electrode; and when the first and second chambers are bounded by and share the intermediate lithium-deintercalated electrode, the intermediate lithium-deintercalated electrode may comprise a porous lithium-deintercalated media affixed to the saltwater-impermeable and electrically conductive substrate of the intermediate lithium-deintercalated electrode.

When the third and fourth chambers are respectively also bounded by the cell boundary lithium-deintercalated electrodes, each of the cell boundary lithium-deintercalated electrodes may comprise a porous lithium-deintercalated media affixed to the saltwater-impermeable and electrically conductive substrate of the cell boundary lithium-deintercalated electrode; and when the third and fourth chambers are respectively also bounded by the cell boundary lithium-intercalated electrodes, each of the cell boundary lithium-intercalated electrodes may comprise a porous lithium-intercalated media affixed to the saltwater-impermeable and electrically conductive substrate of the cell boundary lithium-intercalated electrode.

Each of the porous lithium-intercalated media and the porous lithium-deintercalated media may comprise pores with sizes between 5 nm and 100 microns.

The porous lithium-deintercalated media may comprise at least one of Li_{1.6}Mn_{1.6}O₄, Li_{1.33}Mn_{1.67}O₄, λ-MnO₂, FePO₄, LiₓMn₂O₄, and LiₓFeO₄ for 0<x<1.0.

The porous lithium-intercalated media may comprise at least one of LiMn₂O₄, LiFePO₄, LiₓMn₂O₄, and LiₓFeO₄ for 0<x<1.0.

Each of the lithium-intercalated electrodes and of the lithium-deintercalated electrodes may further comprise a porous conductive substrate. The porous conductive substrate may comprise a continuous porous structure with pores having a size of about 1 micron to about 1,000 microns.

The porous conductive substrate may comprise at least one of carbon paper, carbon cloth, carbon felt, titanium foam, titanium felt, and porous conductive polymer substrate.

The electrochemical lithium recovery apparatus may comprise a power supply electrically coupled to the electrodes, and when the first and second chambers are bounded by and share the intermediate lithium-intercalated electrode, the power supply may be configured to apply a negative voltage to the cell boundary lithium-deintercalated electrodes and a positive voltage to the intermediate lithium-intercalated electrode such that intermediate lithium-intercalated electrode releases lithium and the cell boundary de-intercalated electrodes absorb lithium; and when the first and second chambers are bounded by and share the intermediate lithium-deintercalated electrode, the power supply may apply a negative voltage to the intermediate lithium-deintercalated electrode and a positive voltage to the cell boundary lithium-intercalated electrodes such that intermediate lithium-deintercalated electrode absorbs lithium and the cell boundary lithium-intercalated electrodes release lithium.

The system may further comprise an air flushing manifolding assembly comprising a compressed air source, at least one conduit fluidly coupling the compressed air source to the saltwater chambers and the recovery solution chambers, and at least one control valve positioned along the at least one conduit to permit feeding of air to the saltwater chambers and the lithium recovery solution chambers.

The system may further comprise a water flushing manifolding assembly comprising a cleaning water source, at least one conduit fluidly coupling the cleaning water source to the saltwater chambers, and at least one control valve positioned along the at least one conduit to permit feeding a cleaning water from the cleaning water source to the saltwater chambers.

At least one of the cell boundary electrodes may be double-sided.

At least one of the cell boundary electrodes may be single-sided.

The intermediate lithium-intercalated electrode and the intermediate lithium-deintercalated electrode may be double-sided.

According to another aspect, there is provided a process for extracting lithium from a saltwater using the system as described above. The process comprises respectively feeding the saltwater and the lithium recovery solution to the saltwater chambers and the recovery solution chambers; when the first and second chambers are bounded by and share the intermediate lithium-intercalated electrode, applying a negative voltage to the cell boundary lithium-deintercalated electrodes and a positive voltage to the intermediate lithium-intercalated electrode such that the intermediate lithium-intercalated electrode releases lithium and the cell boundary de-intercalated electrodes absorb lithium; and when the first and second chambers are bounded by and share the intermediate lithium-deintercalated electrode, applying a negative voltage to the intermediate lithium-deintercalated electrode and a positive voltage to the cell boundary lithium-intercalated electrodes such that the intermediate lithium-deintercalated electrode absorbs lithium and the cell boundary intercalated electrodes release lithium.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 is a schematic diagram illustrating a conventional (prior art) electrochemical lithium extraction system, which may be used for extracting lithium compounds from a saltwater to a limited degree.

FIGS. 2A-2D show embodiments of lithium-deintercalated electrodes (FIGS. 2A and B) and lithium-intercalated electrodes (FIGS. 2C and 2D), which are components of an electrochemical lithium recovery apparatus according to an example embodiment.

FIG. 3 is a schematic diagram illustrating an embodiment of an electrochemical apparatus comprising the lithium-deintercalated electrodes and the lithium-intercalated electrodes shown in FIGS. 2A-2D, which may be used for extracting lithium compounds from a saltwater.

FIG. 4 is a schematic diagram illustrating an embodiment of a lithium recovery system comprising the electrochemical apparatus shown in FIG. 3.

For the sake of clarity, not every component is labeled, nor is every component of each embodiment shown where illustration is unnecessary to allow those of ordinary skill in the art to understand the embodiments described herein.

### DETAILED DESCRIPTION

Existing direct lithium recovery technologies such as lithium adsorption and selective lithium ion exchange rely on a passive lithium extraction mechanism and have significant footprints in respect of freshwater usage and acid/base usage. Electrochemical lithium extraction based on the electrochemically driven mechanism of an aqueous lithium-ion battery system has the advantage of high lithium selectivity over other salt ions with minimum chemical consumption.

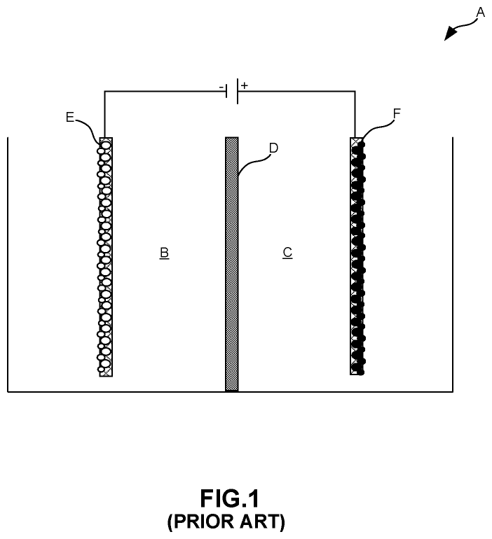

FIG. 1 shows schematically a conventional (prior art) electrochemical lithium extraction system A to recover lithium from a saltwater. The conventional electrochemical lithium extraction system A shown in FIG. 1 comprises two chambers B,C divided by an anion exchange membrane E: one chamber (“saltwater chamber”) B for holding a lithium source saltwater, which comprises lithium and accordingly acts as a lithium source, and the other chamber (“recovery solution chamber”) C for holding a lithium recovery solution. A lithium-deintercalated electrode E is placed within the saltwater in the saltwater chamber B and a lithium-intercalated electrode F is placed within the lithium recovery solution in the recovery solution chamber C. As described herein, a “lithium-intercalated electrode” is an electrode comprising battery materials with crystal lattices into which lithium has been inserted, and a “lithium-deintercalated electrode” is an electrode comprising battery materials with crystal lattices that lack lithium (e.g., lithium may have been removed from the lattices). When an electric potential is applied across the lithium-deintercalated electrode E and the lithium-intercalated electrode F of the conventional electrochemical lithium extraction system A shown in FIG. 1, the lithium-deintercalated electrode E absorbs lithium from the saltwater and the lithium-intercalated electrode F releases lithium into the lithium recovery solution simultaneously. A first cycle of lithium extraction is completed after the lithium-deintercalated electrode E becomes almost lithium-intercalated and/or the lithium-intercalated electrode F becomes almost lithium-deintercalated. To continue with second cycle of lithium extraction, the lithium-intercalated electrode F and the lithium de-intercalated electrode E from the first cycle are cleaned with freshwater and then respectively transferred into the lithium recovery solution and the saltwater to start the second cycle. Alternatively, the saltwater and the lithium recovery solution are swapped into each other's chambers B,C to submerge the electrodes E,F, and the polarity of the electric potential applied across the electrodes E,F is reversed relative to the polarity applied during the first cycle. The lithium recovery cycles may analogously continue until the lithium in the saltwater is almost depleted and has been transferred into the lithium recovery solution.

However, it has been experimentally found that while extracting lithium from a saltwater, the conventional electrochemical lithium extraction system A of FIG. 1 suffers from contamination of the saltwater into the lithium recovery solution, high freshwater usage, and low lithium extraction efficiency when more than two saltwater water chambers B and recovery solution chambers C shown in the conventional electrochemical lithium extraction system A of FIG. 1 are connected as a stack: the lithium-deintercalated electrode E and the lithium-intercalated electrode F for the conventional electrochemical lithium extraction system A are generally prepared by respectively embedding lithium-intercalating materials (e.g., LiMn₂O₄ particles) and lithium de-intercalating materials (e.g., λ-MnO₂ particles) into a porous and conductive substrate (e.g., carbon cloth or metal mesh). The saltwater and the lithium recovery solution mix with each other through the pores of the electrodes E,F, and the saltwater from the saltwater chambers B leaks into the lithium recovery solution in the recovery solution chambers C in a system with multiple chamber assembly, both of which limit the efficiency at which lithium can be separated from other salt ions.

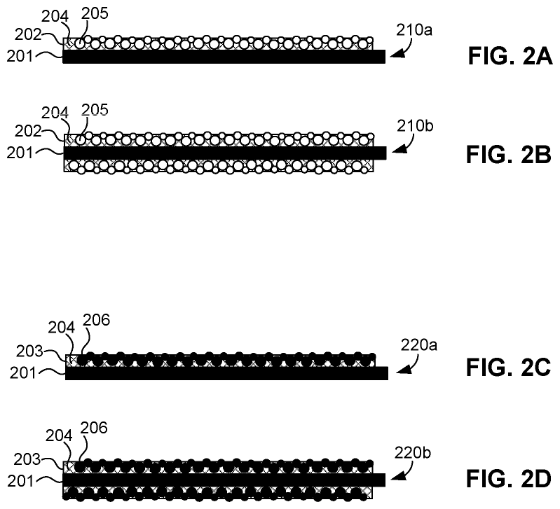

Turning now to FIGS. 2A-2D of the present disclosure, there are respectively shown schematically embodiments of a lithium-deintercalated electrode 210a,b and a lithium-intercalated electrode 220a,b. More particularly, FIG. 2A shows a single-sided lithium-deintercalated electrode 210a; FIG. 2B shows a double-sided lithium-deintercalated electrode 210b; FIG. 2C shows a single-sided lithium-intercalated electrode 220a; and FIG. 2D shows a double-sided lithium-intercalated electrode 220b. The lithium-deintercalated electrodes 210a,b and the lithium-intercalated electrodes 220a,b all comprise a saltwater-impermeable and electrically conductive substrate 201. The lithium-deintercalated electrodes 210a,b further comprise a porous lithium-deintercalated media 202 in contact with one or more surfaces of the substrate 201, while the lithium-intercalated electrodes 210a,b further comprise a porous lithium-intercalated media 203 in contact with one or more surfaces of the substrate 201. As used herein, the porous media 202 and porous media 203 refer to the surface and interior of the media 202,203 comprising pores that a saltwater or a lithium recovery solution can enter and exit while under a hydraulic flowing force. More than 80% of the pores in the media 202,203 have a size between 5 nm and 100 microns in diameter. Pores less than 5 nm are not accessible easily by the saltwater and the lithium recovery solution under a hydraulic flowing force less than 10 psi, while pores larger than 100 microns weaken the contact strength between the porous media 202,203 and the surface of the saltwater-impermeable and electrically conductive substrate 201, leading to delamination between the porous media 202,203 and the substrate 201. The substrate 201 is made from at least one of titanium, graphite, electrically conductive polymer, and a polymer film coated with electrically conductive materials (e.g., carbon powder), and may be a flat sheet having one or two surfaces, or other shapes (e.g., bars or plates, not shown in FIGS. 2A-2D) having one or more surfaces, in contact with the porous lithium-deintercalated media 202 or the porous lithium-intercalated media 203. Examples of the saltwater-impermeable and electrically conductive substrate 201 comprise, for example, a titanium foil and a graphite foil. In FIGS. 2A and 2C, one surface of the substrate 201 is in contact with the porous lithium-deintercalated media 202 and the porous lithium-intercalated media 203 respectively for the single-sided electrodes 210a,220a. In FIGS. 2B and 2D, two opposing surfaces of the substrate 201 are in contact with the porous lithium-deintercalated media 202 and the porous lithium-intercalated media 203 respectively for the double-sided electrodes 210b,220b. In another non-depicted embodiment, the double-sided electrodes 210b,220b may respectively comprise two or more of the single-sided electrodes 210a,220a attached to each other via exposed surfaces of their substrates 201. For the various embodiments of the lithium de-intercalated electrode 210a,b and intercalated electrode 220a,b, the substrate 201 and the media 202,203 may be affixed to each other via suitable means such as mechanical interlocking or by adhesion.

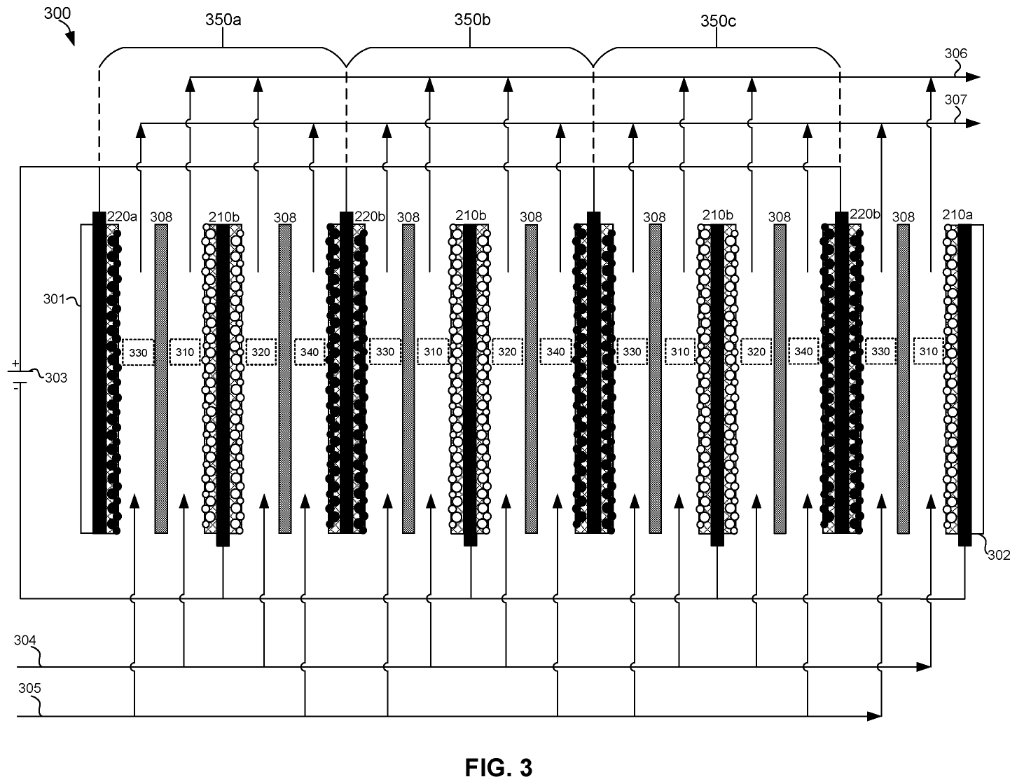

In at least some embodiments, the porous lithium-deintercalated media 202 and the porous lithium-intercalated media 203 respectively comprise a lithium-deintercalated material 205 and a lithium-intercalated material 206. Example lithium-deintercalated materials 205 comprise, for example, Li_{1.6}Mn_{1.6}O₄, Li_{1.33}Mn_{1.67}O₄, λ-MnO₂, FePO₄, LiₓMn₂O₄, and LiₓFeO₄, 0<x<1.0. Example lithium-intercalated materials 206 comprise, for example, LiMn₂O₄, LiFePO₄, LiₓMn₂O₄, and LiₓFeO₄, 0<x<1.0. An electrically conductive additive (e.g., fine carbon black or carbon fiber, not shown in FIGS. 2A-2D) is used to increase the electrical conductivity of the porous media 202,203. A polymer binder (e.g., polyvinyl difluoride, not shown in FIGS. 2A-2D) is used to bind the lithium-deintercalated material 205 or the lithium-intercalated material 206 and the electrically conductive additive together and to attach the resulting bound materials to the saltwater-impermeable and electrically conductive substrate 201. The porous lithium-deintercalated media 202 and the porous lithium-intercalated media 203 provide a specific surface area that interfaces respectively with the saltwater and the lithium recovery solution to facilitate lithium intercalation/deintercalation and ionic conductivity of the electrodes. The saltwater-impermeable and electrically conductive substrate 201 prevents the commingling and the leaking of the saltwater and the lithium recovery solution in an electrochemical lithium recovery apparatus having multiple saltwater chambers and lithium recovery chambers, as described in more detail below in respect of FIG. 3.

In at least some embodiments, the porous lithium-deintercalated media 202 and the porous lithium-intercalated media 203 may comprise a porous electrically conductive substrate 204 having a continuous porous structure, and either the lithium-deintercalated material 205 (for the lithium de-intercalated electrodes 210a,b) or the lithium-intercalated material 206 (for the lithium-intercalated electrodes 220a,b), electrically conductive additive, and polymer binder fill a portion of the continuous pore structure of the porous conductive substrate 204. The pores of the porous electrically conductive substrate 204 have a size of about 1.0 microns to about 1000.0 microns. Examples of suitable porous conductive substrates 204 comprise, for example, carbon paper, carbon cloth, carbon felt, titanium foam, titanium felt, and porous conductive polymer (e.g., polyaniline). In embodiments of the lithium-deintercalated media 202 or the lithium-intercalated media 203 lacking the porous substrate 204, a combination comprising either the lithium-deintercalated material 205 (for the lithium de-intercalated electrodes 210a,b) or the lithium-intercalated material 206 (for the lithium-intercalated electrodes 220a,b), electrically conductive additive, and polymer binder is mixed together into a mixture, and the mixture is coated directly to the conductive substrate 201. The pores of the lithium-deintercalated media 202 or the lithium-intercalated media 203 are formed during the coating process. In at least some embodiments of the lithium-deintercalated media 202 or the lithium-intercalated media 203 comprising the porous conductive substrate 204, a combination comprising either the lithium-deintercalated material 205 (for the lithium de-intercalated electrodes 210a,b) or the lithium-intercalated material 206 (for the lithium-intercalated electrodes 220a,b), electrically conductive additive, and polymer binder is coated onto/into to the porous substrate 204. At least some of the porous substrate's 204 pores are consequently filled. The pores of the lithium-deintercalated media 202 or the lithium-intercalated media 203 accordingly comprise unfilled pores of the porous conductive substrate 204, with the pores formed during the coating process.

FIG. 3 illustrates, according to at least some example embodiments, an electrochemical lithium recovery apparatus 300 that selectively extracts lithium from a saltwater. The apparatus 300 comprises the single-sided lithium deintercalated-electrode 210a and the single-sided lithium-intercalated electrode 220a as two opposing end electrodes; multiple double-sided lithium-deintercalated electrodes 210b and double-sided lithium-intercalated electrodes 220b as intermediate electrodes; and multiple anion exchange membranes (AEMs) 308 separating the double-sided lithium-deintercalated electrodes 210b and lithium-intercalated electrodes 220b. In an alternative embodiment, the double-sided lithium-deintercalated electrodes 210b and double-sided lithium-intercalated electrodes 220b may be used as two opposing end electrodes.

As shown in FIG. 3, the apparatus 300 comprises first through third electrochemical cells 350a-c arranged in series. Generally speaking, an electrochemical cell 350a-c comprises:
a first chamber 310 and an adjacent second chamber 320, wherein the first and second chambers 310,320 are bounded by and share either an intermediate lithium-intercalated electrode 220a,b or an intermediate lithium-deintercalated electrode 210a,b;
a third chamber 330 adjacent the first chamber 310, wherein the first 310 and third chambers 330 are bounded by and share an anion exchange membrane 308;
a fourth chamber 340 adjacent the second chamber 320, wherein the second 320 and fourth chambers 340 are bounded by and share an anion exchange membrane 308, and wherein the third and fourth chambers 330,340 are respectively also bounded by:
   cell boundary lithium-deintercalated electrodes 210a,b when the first and second chambers 310,320 are bounded by and share the intermediate lithium-intercalated electrode 220a,b; and
   cell boundary lithium-intercalated electrodes 220a,b when the first and second chambers 310,320 are bounded by and share the intermediate lithium-deintercalated electrode 210a,b.

As shown in FIG. 3, in at least some embodiments the apparatus 300 may comprise multiple electrochemical cells 350a-c arranged fluidically in parallel. For example, in FIG. 3 the second electrochemical cell 350b is adjacent to the first electrochemical cell 350a and share a double-sided lithium-intercalated electrode 220b; in different embodiments in which cell arrangement and/or construction differs, adjacent cells 350a-c may instead share a double-sided lithium-deintercalated electrode 210b. Regardless, the second electrochemical cell 350b has the same configuration of four chambers 310,320,330,340 as the first electrochemical cell 350a. Similarly, in FIG. 3, the third electrochemical cell 350c is adjacent the second electrochemical cell 350b.

More particularly and as discussed further below, the apparatus 300 can operate in forward or reverse operating modes. When in the forward operating mode, the first and second chambers 310,320 are saltwater chambers for receiving the saltwater, the first and second chambers 310,320 are bounded by and share the double-sided intermediate lithium-deintercalated electrode 210b, the third and fourth chambers 330,340 are recovery solution chambers for receiving the lithium recovery solution, and the third and fourth chambers 330,340 are respectively also bounded by cell boundary lithium-intercalated electrodes 220a,b. For ease of discussion, when discussing the apparatus 300 in forward operating mode, the first and second chambers 310,320 are respectively and interchangeably referred to as the first and second saltwater chambers 310,320, and the third and fourth chambers 330,340 are respectively and interchangeably referred to as the first and second recovery solution chambers 330,340.

In the first electrochemical cell 350a of FIG. 3, one of the cell boundary lithium-intercalated electrodes 220a,b is at the end of the apparatus, and accordingly is a single-sided lithium-intercalated electrode 220a. The other cell boundary lithium-intercalated electrodes 220a,b of the second and third electrochemical cells 350b,c also bound other chambers 310,320,330,340, and accordingly are double-sided lithium-intercalated electrodes 220b. In another embodiment not shown in FIG. 3, both cell boundary lithium-intercalated electrodes 220a,b for the first electrochemical cell 350a may be double-sided.

It has also been experimentally found that the configuration of two adjacent chambers 310,320 separated by a lithium-deintercalated electrode 210b for the saltwater, and/or of the two adjacent chambers 330,340 separated by a lithium-intercalated electrode 220b for the lithium recovery solution, in the apparatus 300 facilitates an even potential distributed among the electrodes 210 and 220 comprising part of the apparatus 300. An uneven potential distribution may cause side reactions. For example, an electrode 210a,b and 220a,b at a relatively high potential compared to other electrodes 210a,b and 220a,b may cause side reactions resulting in H₂, O₂ or Cl₂ gases; similarly, an electrode 210a,b and 220a,b at a relatively low potential compared to other electrodes 210a,b and 220a,b may not have enough potential to drive lithium intercalation/deintercalation.

As described above in respect of FIGS. 2A-2D, the lithium-deintercalated electrode 210 and the lithium-intercalated electrode 220 comprise the saltwater-impermeable and conductive substrate 201, and the porous lithium-deintercalated media 202 (for the lithium-deintercalated electrode 210) and the porous lithium-intercalated media 203 (for the lithium-intercalated electrode 220) are in contact with one or more surfaces of the saltwater-impermeable and electrically conductive substrate 201. It has been experimentally found that the saltwater-impermeable and electrically conductive substrate 201 within the apparatus 300 helps to prevent the saltwater flowing in saltwater chambers 310,320 from mixing with the lithium recovery solution flowing in recovery solution chambers 330,340, and to prevent the saltwater and the lithium recovery solution from leaking across the electrodes 210,220 and the AEMs 308. The saltwater-impermeable and electrically conductive substrate 201 and the AEM 308 support each other to seal the chambers.

As shown in FIG. 3, the cells 350a-c may be assembled as a stack, with each such electrochemical cell 350a-c comprising four chambers 310,320,330,340 and each chamber 310,320,330,340 bounded by an AEM 308 and either a lithium-deintercalated electrode 210a,b or a lithium-intercalated electrode 220a,b, with each of the cells 350a-c having at least one of the following configurations:
i) Lithium-intercalated electrode 220a or 220b/Recovery solution chamber 330/AEM 308/Saltwater chamber 310/Lithium-deintercalated electrode 210b/Saltwater chamber 320/AEM/Recovery solution chamber 340 (this is the configuration depicted in FIG. 3);
ii) Recovery solution chamber 330/AEM 308/Saltwater chamber 310/Lithium-deintercalated electrode 210b/Saltwater chamber 320/AEM 308/Recovery solution chamber 340/Lithium-intercalated electrode 220a or 220b;
iii) Lithium-deintercalated electrode 210a or 220b/Saltwater chamber 310/AEM 308/Recovery solution chamber 330/AEM 308/Lithium-intercalated electrode 220b/Recovery solution chamber 340/AEM 308/Saltwater chamber 320; and
iv) Saltwater chamber 310/AEM 308/Recovery solution chamber 330/AEM 308/Lithium-intercalated electrode 220b/Recovery solution chamber 340/AEM 308/Saltwater chamber 320/Lithium-deintercalated electrode 210a or 220b.

In at least some embodiments, including as depicted in FIG. 3, the apparatus 300 further comprises two end plates 301,302 to hold together the chambers 310,320,330,340, spacers (not shown in FIG. 3) interposed between the AEMs 308 and neighboring electrodes 210a,b and 220a,b to create the separation required for the chambers 310,320,330,340 to be able to hold liquid, and gaskets (not shown in FIG. 3) helping seal the electrodes 210a,b and 220a,b and the spacers.

In certain other non-depicted embodiments, the double-sided electrodes 210b,220b depicted in FIG. 2 may be replaced with differently shaped electrodes. For example, the double-sided electrodes 210b,220b may be replaced with electrodes having more than two sides (e.g., square-shaped electrodes), with adjacent chambers 310,320,330,340 contacting different sides of the differently shaped electrode. As another example, the double-sided electrodes 210b,220b may be replaced with a single-sided electrode, such as a spherical electrode, with different portions of the spherical electrode respectively contacting adjacent chambers.

During operation, a lithium-containing saltwater is fed via conduit 304 to the saltwater chambers 310,320, and a lithium recovery solution is fed via conduit 305 to the recovery solution chambers 330,340. A power supply 303 applies a negative potential to the lithium-deintercalated electrodes 210a,b and a positive potential to the lithium-intercalated electrodes 220a,b under any one of several operational modes, including modes in which voltage is held constant, current is held constant, and current is pulsed. In the embodiment shown in FIG. 3, the electrodes 210a,b and 220a,b are arranged electrically in parallel to receive the potential applied by the power supply 303. In another embodiment not shown in FIG. 3, the electrodes 210a,b and 220a,b are arranged electrically in series to receive the potential from the power supply 303. Under an electrical field resulting from the voltage applied by the power supply 303, lithium in the saltwater is intercalated into the lithium-deintercalated electrodes 210a,b and lithium in the lithium-intercalated electrodes 220a,b is released into the lithium recovery solution. Some anions (e.g., chloride) in the saltwater migrate cross the AEMs 308 and into the lithium recovery solution, thereby maintaining overall charge neutrality for the saltwater and the lithium recovery solution. Following processing by the apparatus 300, the saltwater has had depleted from it at least some lithium compounds (e.g., lithium chloride) and the lithium recovery solution has been accordingly enriched with lithium compounds, and the saltwater and lithium recovery solution are directed via conduits 306,307 out of the apparatus 300.

After the lithium-deintercalated electrodes 210a,b become almost lithium-intercalated and/or the lithium-intercalated electrodes 220a,b become almost lithium-deintercalated, the operating of the apparatus 300 is reversed to continue the next lithium extraction cycle by simultaneously reversing the polarity of the voltage applied to the electrodes 210a,b and 220a,b by the power supply 303, and swapping the feeding of the saltwater from chambers 310,320 into chambers 330,340 and the feeding of the lithium recovery solution from chambers 330,340 into chambers 310,320 (i.e., when in reverse operation, the saltwater chambers 310,320 in forward operation effectively become recovery solution chambers and the recovery solution chambers 330,340 in forward operation effectively become saltwater chambers). Accordingly, when in the reverse operating mode, the first and second chambers 310,320 are recovery solution chambers for receiving the lithium recovery solution, the first and second chambers 310,320 are bounded by and share the double-sided intermediate lithium-intercalated electrode generated from the apparatus's 300 prior forward operation, the third and fourth chambers 330,340 are saltwater chambers for receiving the saltwater, and the third and fourth chambers 330,340 are respectively also bounded by cell boundary lithium-deintercalated electrodes generated from the apparatus's 300 prior forward operation.

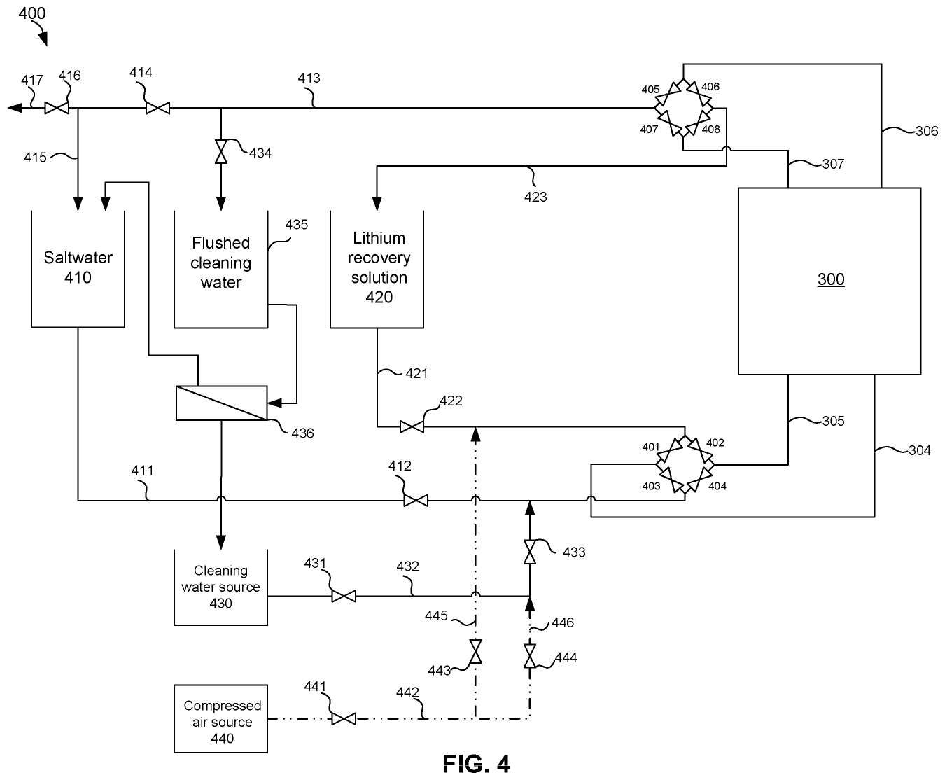

FIG. 4 illustrates, according to one example embodiment, a lithium recovery system 400 that selectively extracts lithium compounds from a saltwater. The system 400 comprises the apparatus 300, which electrochemically extracts lithium compounds from a saltwater as described above in respect of FIG. 3. The system 400 further comprises a water flushing manifolding assembly comprising a cleaning water source 430, at least one conduit 432 fluidly coupling the cleaning water source 430 to the saltwater chambers 310,320 in the apparatus 300, control valves 431,433 along the at least one conduit 432 to permit feeding a cleaning water from the cleaning water source 430 to the saltwater chambers 310,320 in the apparatus 300, and an air flushing manifolding assembly comprising a compressed air source 440, conduits 442,445,446 fluidly coupling the compressed air source 440 to the saltwater chambers 310,320 and the lithium recovery solution chambers 330,340 in the apparatus 300, and control valves 441,443,444 along conduits 432,445,446 to permit feeding air to the saltwater chambers 310,320 and the lithium recovery solution chambers 330,340 in the apparatus 300 to flush at some of the saltwater and lithium recovery solution out of the apparatus 300.

According to at least some embodiments and with reference to FIG. 4, a process for extracting lithium from a saltwater uses the apparatus 300 such as depicted in FIG. 3, and comprises respectively feeding the saltwater and the lithium recovery solution to the saltwater chambers 310,320 and the recovery solution chambers 330,340, and appropriately applying voltage to the electrodes 210a,b and 220a,b comprising the apparatus 300 depending on the apparatus's 300 configuration. More particularly, when the first and second chambers 310,320 are bounded by and share the intermediate lithium-intercalated electrode 220a,b, a negative voltage is applied to the cell boundary lithium-deintercalated electrodes 210a,b and a positive voltage is applied to the intermediate lithium-intercalated electrode 220a,b such that the intermediate lithium-intercalated electrode 220a,b releases lithium and the cell boundary de-intercalated electrodes 210a,b absorb lithium. And in contrast, when the first and second chambers 310,320 are bounded by and share the intermediate lithium-deintercalated electrode 210a,b, a negative voltage is applied to the intermediate lithium-deintercalated electrode 210a,b and a positive voltage is applied to the cell boundary lithium-intercalated electrodes 220a,b such that the intermediate lithium-deintercalated electrode 210a,b absorbs lithium and the cell boundary lithium-intercalated electrodes 220a,b release lithium.

In at least some embodiments, the lithium-deintercalated electrode 210a,b and the lithium-intercalated electrode 220a,b comprise the saltwater-impermeable and electrically conductive substrate 201, and the porous lithium-deintercalated media 202 (for the lithium-deintercalated electrode 210a,b) and the porous lithium-intercalated media 203 (for the lithium-intercalated electrode 220a,b) are in contact with one or more surfaces of the saltwater-impermeable and conductive substrate 201.

In operation, a lithium-containing saltwater is fed from a saltwater container 410 via conduits 411,304 and control valves 412,403 to the saltwater chambers 310,320 in the apparatus 300, and a lithium recovery solution is fed from a lithium solution container 420 via conduits 421,305 and control valves 422,402 to the lithium recovery chambers 330,340 in the apparatus 300. The saltwater may be one of a salar brine, a geothermal brine and a produced water resulting from oil/gas production. The saltwater may be pretreated through any one or more pretreatment units (not shown in FIG. 4), such as a gas flotation unit, a sedimentation unit, a media filter, and a microfilter to remove organics, oil/grease, and/or suspended solids.

The saltwater exiting from the apparatus 300 has at least some of the lithium compounds in it depleted by virtue of being processed by the apparatus 300, and is directed via conduits 306,413,415 and control valves 405,414 back to the saltwater container 410 and/or is discharged via control valve 416 and conduit 417 out of the system 400. Analogously, the lithium recovery solution exiting from the apparatus 300 has been enriched with lithium compounds by virtue of being processed by the apparatus 300 and is directed via conduits 307,423 and control valve 408 back to the lithium recovery solution container 420.

When the apparatus 300 is operated under a constant electrical potential, the current density across the AEM 308 and the apparatus 300 may gradually decrease when the lithium-deintercalated electrodes 210a,b gradually become lithium-intercalated and/or the lithium-intercalated electrodes 220a,b gradually become lithium-deintercalated. When the current density decreases to a preset level (e.g., <2 A/m²), the process of lithium intercalation and lithium deintercalation is paused by stopping the feeding of the saltwater and the lithium recovery solution to the apparatus 300. The potential applied to the apparatus 300 may also be suspended. Some of the saltwater and some of the lithium recovery solution may be retained within the chambers 310,320,330,340 and the conduits of the apparatus 300. The retained saltwater within the apparatus 300 may contaminate the lithium recovery solution for next cycle of lithium extraction. Consequently, a cleaning operation may be applied to flush out of the apparatus 300 at least some of the saltwater and/or lithium recovery solution prior to commencing the next cycle of lithium extraction.

For example, in at least some embodiments the cleaning operation comprises feeding air to the saltwater chambers 310,320 and the recovery solution chambers 330,340 to flush at least some of the saltwater in the saltwater chambers 310,320 and at least some of the lithium recovery solution in the recovery solution chambers 330,340 out of the apparatus 300 while the saltwater and the lithium recovery solution are not being pumped through the apparatus 300. Air from the compressed air source 400 is fed via conduits 442,445,305 and control valves 441,443,402 to the recovery solution chambers 330,340, and is directed via conduits 442,443,304 and control valves 441,444,433,403 to the saltwater chambers 310,320. The saltwater displaced by air out of the apparatus 300 is directed via conduits 306,413,415 and control valves 405,414 to the saltwater container 410. The lithium recovery solution displaced by air out of the apparatus 300 is directed via conduits 307,423 and control valve 408 to the lithium recovery solution container 420.

The cleaning operation may further comprise feeding a cleaning water to the saltwater chambers 310,320 to flush at least some of the saltwater out of the saltwater chambers 310,320 when the saltwater and the lithium recovery solution are not being pumped to the apparatus 300 and/or after the air flushing operation described above. Freshwater may be used as the cleaning water. For example, freshwater from the cleaning water source 430 may be fed via conduits 432,304 and control valves 431,433,403 to the saltwater chambers 310,320. The saltwater flushed out of the apparatus 300 may be diluted with the freshwater used for the flushing, and the mixture of the saltwater and freshwater may have a lower total dissolved solids content than the saltwater alone. The saltwater diluted with the freshwater may be directed via conduits 306,413 and control valves 405,434 to a flushed cleaning water container 435. The saltwater diluted with the freshwater in the flushed cleaning water container 435 may be recovered by a reverse osmosis unit 436 to produce an RO permeate and an RO concentrate. The RO permeate may be recycled for use as cleaning water and consequently directed to the cleaning water source 430, and similarly the RO concentrate may be directed to the saltwater container 410.

In the embodiment shown in FIG. 4, the air and the clean water are flushed through the apparatus 300 from the bottom of the apparatus 300 to the top. In an alternative embodiment (not shown), the air and the clean water are flushed through the apparatus 300 from its top to its bottom, or from one side to the other side.

After the cleaning operation is completed, the next cycle of lithium extraction through the apparatus 300 is continued by reversing the apparatus's 300 operation as described above. In the context of FIG. 4, this comprises simultaneously reversing the voltage applied to the electrodes 210a,b and 220a,b, swapping the feeding of the saltwater from chambers 310,320 into chambers 330,340, and the feeding of the lithium recovery solution from chambers 330,340 into chambers 310,320. The swapping is completed through operating control valves 401-408.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise. It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups.

Directional terms such as “top”, “bottom”, “upwards”, “downwards”, “vertically”, and “laterally” are used in the description for the purpose of providing relative reference only, and are not intended to suggest any limitations on how any article is to be positioned during use, or to be mounted in an assembly or relative to an environment.

It is contemplated that any part of any aspect or embodiment discussed in this specification can be implemented or combined with any part of any other aspect or embodiment discussed in this specification.

One or more example embodiments have been described by way of illustration only. This description is presented for purposes of illustration and description, but is not intended to be exhaustive or limited to the form disclosed. It will be apparent to persons skilled in the art that a number of variations and modifications can be made without departing from the scope of the claims.

1. A system for extracting lithium from a saltwater, the system comprising an electrochemical lithium recovery apparatus comprising a first electrochemical cell, the first electrochemical cell comprising:
a first chamber and an adjacent second chamber, wherein the first and second chambers are bounded by and share either an intermediate lithium-intercalated electrode or an intermediate lithium-deintercalated electrode;
a third chamber adjacent the first chamber, wherein the first and third chambers are bounded by and share an anion exchange membrane;
a fourth chamber adjacent the second chamber, wherein the second and fourth chambers are bounded by and share an anion exchange membrane, and wherein the third and fourth chambers are respectively also bounded by:
cell boundary lithium-deintercalated electrodes when the first and second chambers are bounded by and share the intermediate lithium-intercalated electrode; and
cell boundary lithium-intercalated electrodes when the first and second chambers are bounded by and share the intermediate lithium-deintercalated electrode.

2. The system of claim 1, wherein the first and second chambers are saltwater chambers for receiving the saltwater, the first and second chambers are bounded by and share the intermediate lithium-deintercalated electrode, the third and fourth chambers are recovery solution chambers for receiving a lithium recovery solution, and the third and fourth chambers are respectively also bounded by the cell boundary lithium-intercalated electrodes.

3. The system of claim 1, wherein the first and second chambers are recovery solution chambers for receiving a lithium recovery solution, the first and second chambers are bounded by and share the intermediate lithium-intercalated electrode, the third and fourth chambers are saltwater chambers for receiving the saltwater, and the third and fourth chambers are respectively also bounded by the cell boundary lithium-deintercalated electrodes.

4. The system of claim 1, wherein each of the intermediate electrodes shared by the first and second chambers and the cell boundary electrodes respectively bounding the first and second chambers comprises a saltwater-impermeable and electrically conductive substrate.

5. The system of claim 4, wherein the saltwater-impermeable and electrically conductive substrate comprises a sheet substrate made from a material comprising at least one of titanium, graphite, a conductive polymer, and a polymer film coated with conductive materials.

6. The system of claim 4, wherein the electrochemical lithium recovery apparatus further comprises a second electrochemical cell sharing at least one of the cell boundary electrodes with the first electrochemical cell, wherein the second electrochemical cell comprises an identical configuration of the four chambers as the first electrochemical cell.

7. The system of claim 4, wherein, when the first and second chambers are bounded by and share the intermediate lithium-intercalated electrode, the intermediate lithium-intercalated electrode comprises a porous lithium-intercalated media affixed to the saltwater-impermeable and electrically conductive substrate of the intermediate lithium-intercalated electrode; and
wherein, when the first and second chambers are bounded by and share the intermediate lithium-deintercalated electrode, the intermediate lithium-deintercalated electrode comprises a porous lithium-deintercalated media affixed to the saltwater-impermeable and electrically conductive substrate of the intermediate lithium-deintercalated electrode.

8. The system of claim 4, wherein, when the third and fourth chambers are respectively also bounded by the cell boundary lithium-deintercalated electrodes, each of the cell boundary lithium-deintercalated electrodes comprises a porous lithium-deintercalated media affixed to the saltwater-impermeable and electrically conductive substrate of the cell boundary lithium-deintercalated electrode; and
wherein, when the third and fourth chambers are respectively also bounded by the cell boundary lithium-intercalated electrodes, each of the cell boundary lithium-intercalated electrodes comprises a porous lithium-intercalated media affixed to the saltwater-impermeable and electrically conductive substrate of the cell boundary lithium-intercalated electrode.

9. The system of claim 7, wherein each of the porous lithium-intercalated media and the porous lithium-deintercalated media comprises pores with sizes between 5 nm and 100 microns.

10. The system of claim 7, wherein the porous lithium-deintercalated media comprises at least one of Li_{1.6}Mn_{1.6}O₄, Li_{1.33}Mn_{1.67}O₄, λ-MnO₂, FePO₄, LiₓMn₂O₄, and LiₓFeO₄ for 0<x<1.0.

11. The system of claim 7, wherein the porous lithium-intercalated media comprises at least one of LiMn₂O₄, LiFePO₄, LiₓMn₂O₄, and LiₓFeO₄ for 0<x<1.0.

12. The system of claim 7, wherein each of the porous lithium-intercalated media and of the pore lithium-deintercalated media further comprises a porous conductive substrate, wherein the porous conductive substrate comprises a continuous porous structure with pores having a size of about 1 micron to about 1,000 microns.

13. The system of claim 12, wherein the porous conductive substrate comprises at least one of carbon paper, carbon cloth, carbon felt, titanium foam, titanium felt, and porous conductive polymer substrate.

14. The system of claim 1, wherein the electrochemical lithium recovery apparatus comprises a power supply electrically coupled to the electrodes,
wherein, when the first and second chambers are bounded by and share the intermediate lithium-intercalated electrode, the power supply is configured to apply a negative voltage to the cell boundary lithium-deintercalated electrodes and a positive voltage to the intermediate lithium-intercalated electrode such that intermediate lithium-intercalated electrode releases lithium and the cell boundary de-intercalated electrodes absorb lithium; and
wherein, when the first and second chambers are bounded by and share the intermediate lithium-deintercalated electrode, the power supply applies a negative voltage to the intermediate lithium-deintercalated electrode and a positive voltage to the cell boundary lithium-intercalated electrodes such that intermediate lithium-deintercalated electrode absorbs lithium and the cell boundary lithium-intercalated electrodes release lithium.

15. The system of claim 2, further comprising an air flushing manifolding assembly comprising a compressed air source, at least one conduit fluidly coupling the compressed air source to the saltwater chambers and the recovery solution chambers, and at least one control valve positioned along the at least one conduit to permit feeding of air to the saltwater chambers and the lithium recovery solution chambers.

16. The system of claim 2, further comprising a water flushing manifolding assembly comprising a cleaning water source, at least one conduit fluidly coupling the cleaning water source to the saltwater chambers, and at least one control valve positioned along the at least one conduit to permit feeding a cleaning water from the cleaning water source to the saltwater chambers.

17. The system of claim 1, wherein at least one of the cell boundary electrodes is double-sided.

18. The system of claim 1, wherein at least one of the cell boundary electrodes is single-sided.

19. The system of claim 1, wherein the intermediate lithium-intercalated electrode and the intermediate lithium-deintercalated electrode are double-sided.

20. A process for extracting lithium from a saltwater using a system for extracting lithium from a saltwater, the system comprising an electrochemical lithium recovery apparatus comprising a first electrochemical cell, the first electrochemical cell comprising:
a first chamber and an adjacent second chamber, wherein the first and second chambers are bounded by and share either an intermediate lithium-intercalated electrode or an intermediate lithium-deintercalated electrode;
a third chamber adjacent the first chamber, wherein the first and third chambers are bounded by and share an anion exchange membrane;
a fourth chamber adjacent the second chamber, wherein the second and fourth chambers are bounded by and share an anion exchange membrane, and wherein the third and fourth chambers are respectively also bounded by:
cell boundary lithium-deintercalated electrodes when the first and second chambers are bounded by and share the intermediate lithium-intercalated electrode; and
cell boundary lithium-intercalated electrodes when the first and second chambers are bounded by and share the intermediate lithium-deintercalated electrode,
wherein the first and second chambers are saltwater chambers for receiving the saltwater, the first and second chambers are bounded by and share the intermediate lithium-deintercalated electrode, the third and fourth chambers are recovery solution chambers for receiving a lithium recovery solution, and the third and fourth chambers are respectively also bounded by the cell boundary lithium-intercalated electrodes,
and wherein the process comprises:
respectively feeding the saltwater and the lithium recovery solution to the saltwater chambers and the recovery solution chambers; and either:
applying a negative voltage to the cell boundary lithium-deintercalated electrodes and a positive voltage to the intermediate lithium-intercalated electrode such that the intermediate lithium-intercalated electrode releases lithium and the cell boundary de-intercalated electrodes absorb lithium, wherein the first and second chambers are bounded by and share the intermediate lithium-intercalated electrode; or
applying a negative voltage to the intermediate lithium-deintercalated electrode and a positive voltage to the cell boundary lithium-intercalated electrodes such that the intermediate lithium-deintercalated electrode absorbs lithium and the cell boundary intercalated electrodes release lithium, wherein the first and second chambers are bounded by and share the intermediate lithium-deintercalated electrode.

21.-35. (canceled)
